(19) United States
(12) Patent Application Publication
(10) Pub. No.: US 2024/0289013 A1
(43) Pub. Date: Aug. 29, 2024

(54) SINGLE-HAND KEYBOARD FOR HAND-HELD COMPUTER DEVICES

(71) Applicant: ZHENJIE SHEN, Beijing (CN)

(72) Inventor: ZHENJIE SHEN, Beijing (CN)

(21) Appl. No.: 18/358,082

(22) Filed: Jul. 25, 2023

(30) Foreign Application Priority Data
Feb. 25, 2023 (CN) 202320312857.1

(51) Int. Cl. G06F 3/04886

(52) U.S. Cl. CPC G06F 3/04886; B41J 5/10; G06F 3/0219

(57) ABSTRACT

The disclosure describes a single-handed keyboard for handheld computer devices. A new arrangement of keys is introduced to enable handheld computer device users to input information smoothly with only one hand while holding it with the other hand. Method disclosed by the invention is: reverse the horizontal order of the keys in one hand's area of a dual-handed keyboard and insert the re-ordered keys into rows or columns in the other hand's area to form a single-handed full keyboard with all re-ordered and inserted letters or symbols as separate keys that do not share with letters or symbols in the charge of the same finger of the other hand. The single-handed keyboard may be a physical keyboard, a virtual keyboard or any other types of keyboards. Along with the rapid development of electronic product science and technology, single-handed keyboard will contribute to the evolution of computer devices towards higher portability.

### CROSS-REFERENCE TO RELATED APPLICATIONS

This is a U.S. patent application which claims the priority and benefit of Chinese Patent Application Number 202320312857.1, filed on Feb. 25, 2023, the disclosure of which is incorporated herein by reference in its entirety.

### TECHNICAL FIELD

This invention relates to input method solutions for handheld computer devices.

### BACKGROUND

Handheld computer devices are devices with display-screen or touch-screen that can be held by hand, such as cellphones, smart phones, personal digital assistants, tablets or net-books and so on.

Double-handed keyboards are keyboards that are widely used on computers, such as PCs, note books or computer servers, even handheld computer devices being used nowadays. The method claimed in this invention may be derived from any kinds of dual handed keyboards, including QWERT keyboard, Dvorak keyboard and so on.

### SUMMARY

Nowadays, handheld computer devices are developing with rapid speed. They are portable and making people's life more and more convenient. Those portable devices, such as tablets, smart phones, e-readers etc., enable people to do a lot of businesses or entertainments anywhere. People can surf the internet, do shopping, order meal, edit documents or even program with them.

But handheld computer devices are different from traditional computers because they must be held with one hand. Thus users can't input or find it difficult to input information into those devices with both their two hands. And now we are still using double-handed keyboards designed for old fashion computers, which obviously becomes an obstacle for the further development of handheld computer devices. Because, with the double-handed keyboard, while using handheld computer devices, people are unable to hold the device firmly and input information smoothly at the same time.

According to the medical science, mirror movements are the easiest movements to perform for two hands of a person. So, in this invention, the horizontal order of keys in the area of one hand on a double-handed keyboard is reversed and the re-ordered keys are inserted between the rows or columns in the area of the other hand. Users can use the same finger of the left(right) hand to type the keys on a keyboard, which originally should be typed with a specific finger of the right(left) hand on a double-handed keyboard. For example, they can type a key, which originally should be typed with the left index finger, with their right index finger. Or they can type the key, which originally should be typed with the left middle finger, with their right middle finger and so on. And during the input process, there is no need for users to input any extra control signals to switch channels for information input that originally should be done with both two hands.

There are already many office softwares, programming softwares and social communication softwares developed for handheld computer devices. People also have requirements to work with those devices because they are portable and provide the possibility to work anywhere. But the dual handed keyboard have long been a problem since users of handheld computer devices can not input information with both two hands simultaneously when they are holding the device with one hand. The invention makes user-input no longer a bottleneck for the usage of those devices as it enables users to input with only one hand smoothly without extra efforts.

There are already some single hand input solutions for handheld devices. But the mirror movement method involved by this invention makes finger movements easier to practice while using a single handed keyboard. And the disclosed arrangement of keys is compatible with double-handed keyboards so that much efforts can be saved from learning a new keyboard. Users can keep their dual handed keyboard using habit and switch themselves smoothly between traditional computers and handheld computer devices.

While using the one-handed keyboard described in this invention, users don't need to input any extra control signals to switch between left hand input and right hand input. Normal dual-handed keyboards are designed for double-hand manipulation and two hands share tasks equally. Existing methods that need user to press some control key to switch between left hand input and right hand input may involve much efforts and make the whole process not so smooth. For almost all the cases, user inputs contain letters both for left hand and right hand and they are interleaved, which may lead to frequent switching during input process, wasting lots of efforts. Finger movement may be enlarged a little for some keys in this invention. But larger size of a keyboard brings greater finger movement too. And there are many keyboards and devices of different sizes existing on the market and most people will not reject a keyboard only for its size. Thus, the problem can be ignored.

### BRIEF DESCRIPTION OF DRAWINGS

FIG. 1. shows a one-handed keyboard(right-hand keyboard). The horizontal orders of keys in the left hand area on a double-handed keyboard are reversed. Keeping the reversed order, those keys are inserted between the rows in the right-hand area.

FIG. 2. shows another type of single handed keyboard. The keys in the left hand area may also be inserted between columns of the keys in the right hand area after their horizontal orders are reversed.

FIG. 3. and FIG. 4. illustrate a physical right hand keyboard for handheld computer devices. The horizontal orders of keys in the left hand area on a double-handed keyboard are reversed. Keeping the reversed order, those keys are inserted between the rows in the right-hand area.

FIG. 5. and FIG. 6. illustrate a virtual right hand keyboard for handheld computer devices.

FIG. 7., FIG. 8. and FIG. 9 take the QWERT keyboard as an example to illustrate the method to form a new key arrangement for single handed keyboard: reverse the order of QWERT on a dual handed keyboard horizontally; insert the re-ordered keys between rows or columns in the right hand's area; get a new arrangement of keys for a single hand keyboard.

FIG. 10. shows the whole process to get the new arrangement for 26 English letters on a one-handed keyboard.

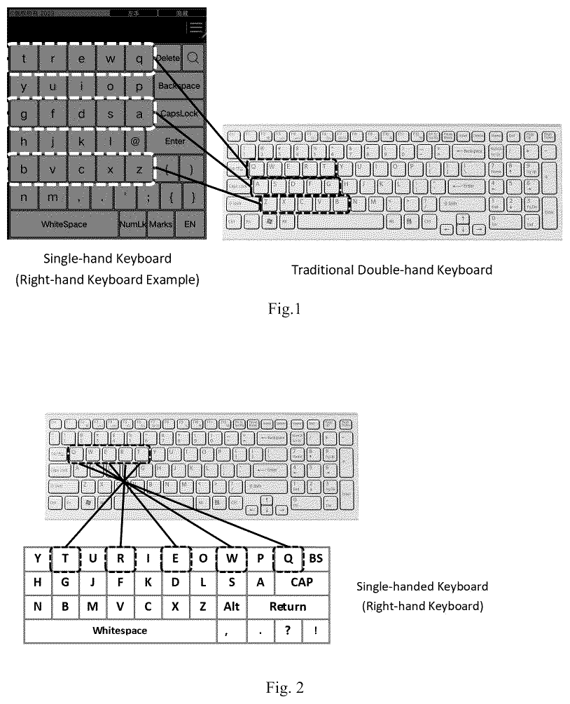

### DETAILED DESCRIPTION

Two exemplary embodiments of the invention will hereinafter be described in detail with reference to the accompanying drawings.

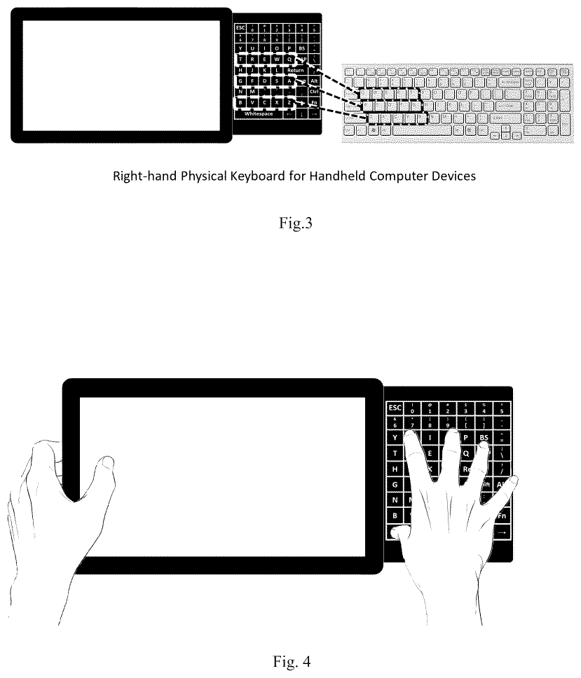

FIG. 3 and FIG. 4 show a physical right-hand keyboard with an arrangement of keys described in this invention.

As shown in FIG. 3 and FIG. 4, the horizontal sequence of keys in the left hand area of a double-handed keyboard is reversed first and then the re-ordered keys are inserted between the rows in the right hand area to form a right-hand keyboard. It describes a physical keyboard placed to the right side of the display screen of the device.

In this example, ‘QWERT’ in the left hand area on a QWERT keyboard becomes ‘TREWQ’. The re-ordered keys ‘TREWQ’ are inserted between the row ‘YUIOP’ and the row ‘HJKL’ in the right hand area. Similarly, the row ‘ASDFG’ in the left hand area changes to ‘GFDSA’ and the re-ordered keys are inserted between the row ‘HJKL’ and the row ‘NM’ in the right hand area; the row ‘ZXCVB’ in the left hand area becomes ‘BVCXZ’ and the re-ordered keys are placed under the row ‘NM’. Finally, the arrangement of keys on the one-handed keyboard is as following:
The first line: ‘YUIOP’;
The second line: ‘TREWQ’;
The third line: ‘HJKL’;
The fourth line: ‘GFDSA’;
The fifth line: ‘NM’;
The last line: ‘BVCXZ’.

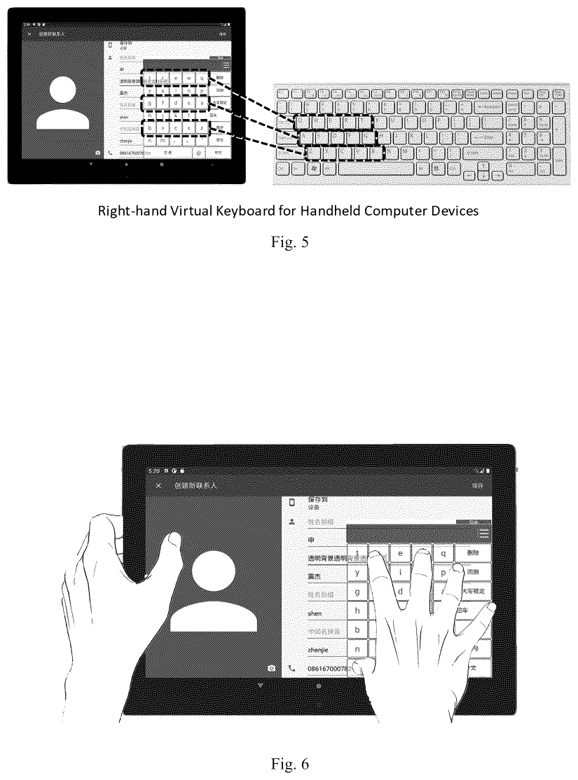

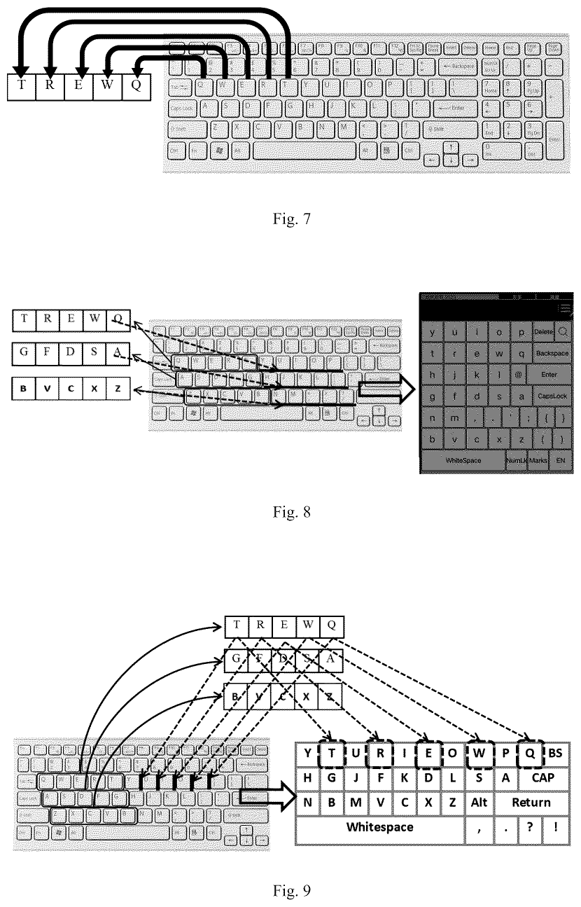

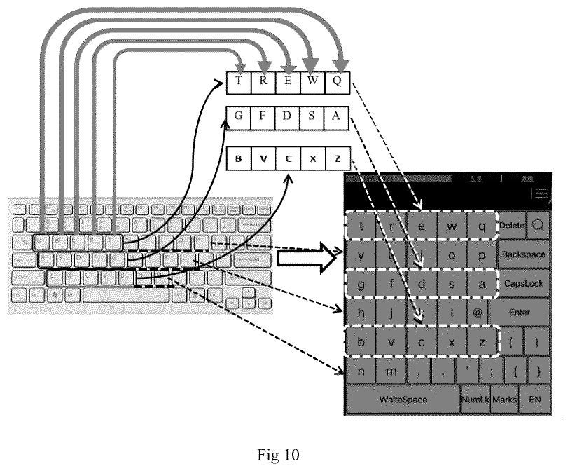

FIG. 5 and FIG. 6 show a virtual right-hand keyboard with an arrangement of keys described in this invention.

As shown in FIG. 5. and FIG. 6., the horizontal sequence of keys in the left hand area of a double-handed keyboard is reversed and then, with the new order, those keys are inserted between the rows in the right hand area to form a right hand keyboard. It describes a virtual keyboard displayed on the right side of the display screen of the device.

For the best modes of the invention as shown in FIG. 3˜FIG. 6, user can type the keys ‘e’, ‘d’, ‘c’ originally in the charge of the left hand middle finger with his/her middle finger of the right hand; type the keys ‘r’, ‘t’, ‘f’, ‘g’, ‘v’, ‘b’ originally in the charge of the left hand index finger with his/her index finger of the right hand; type the keys ‘w’, ‘s’, ‘x’ originally in the charge of the left hand third finger with his/her third finger of the right hand; type the keys ‘q’, ‘a’, ‘z’ originally in the charge of the left hand little finger with his/her little finger of the right hand. He/she will find it easy to input with the single-hand keyboard if one is already able to use the traditional dual handed keyboards because such mirror movements are the easiest movements to perform for two hands of a person. During the whole input process, there is no need for users to input any other extra control signals to enable single hand information input that originally should be done with both two hands.

This invention is not confined to the two examples of best modes given above. Essence of the idea is to reverse the horizontal order of keys in one hand's area on a double-handed keyboard and insert those re-ordered keys between rows or columns in the other hand's area to form a single handed keyboard with each re-ordered letter as a separate key.

Method described in this invention can be implemented as both physical keyboard and virtual keyboard, similar as existing double-handed physical keyboards and virtual keyboards. What's different is only the arrangement of keys.

Physical keyboard with the new arrangement of keys described in this invention may be a fixed keyboard on a handheld computer device. As a fixed keyboard, the physical keyboard may be a keyboard placed to any sides of the screen of the device with any methods, such as a folding one, a keyboard with rotary joint or a keyboard placed to any side of the screen of the handheld computer device.

Physical keyboard with the arrangement of keys described in this invention may also be a separate keyboard connected to a handheld computer device. In the form of a separate keyboard, the physical keyboard may be connected to the handheld computer device on any sides of the device through any interfaces, such as USB, type-C, Bluetooth and so on.

Virtual keyboard with the arrangement of keys described in this invention may be displayed on any sides of the screen on a handheld computer device. The virtual keyboard may also be transparent, floating and folding so as to let users make full use of the limited area of the screen. Virtual keyboard with the arrangement of keys described in this invention may be developed with any programming languages.

One-handed keyboard with the new arrangement of keys described in this invention may also be implemented as a projection keyboard.

What is claimed is:

1. A one-handed keyboard for handheld computer devices comprising: a new arrangement of keys deriving from the key arrangements of any dual handed keyboards, wherein the horizontal orders of keys in one hand area of a double-handed keyboard are reversed and the re-ordered keys are inserted between rows or columns in the other hand area of the double-handed keyboard.

2. The one-handed keyboard according to claim 1, wherein the re-arrangement method is making the keys in one hand area of a double-handed keyboard keep the horizontally reversed order and be inserted between any rows or columns of the double-handed keyboard; and the rows or columns of the double-handed keyboard include keyboard borders.

3. The one-handed keyboard according to claim 1, wherein the one-handed keyboard has the re-ordered letters or symbols placed on the keyboard as separate keys that do not share with other letters or symbols in the charge of the same finger of the other hand.

4. The one-handed keyboard according to claim 1, wherein the double-handed keyboards are any keyboards designed for double-hand manipulation.

5. The one-handed keyboard according to claim 1, wherein the horizontal direction is the direction of a line made up of keys for different fingers of a hand.
